(19) United States
(12) Patent Application Publication
(10) Pub. No.: US 2013/0006459 A1
(43) Pub. Date: Jan. 3, 2013

(54) CONTROL SYSTEM AND METHOD FOR A MOTOR

(75) Inventors: Sang Joon Kim, Seoul (KR); Sungdeok Kim, Sungnam (KR)

(73) Assignees: KIA MOTORS CORPORATION, Seoul (KR); HYUNDAI MOTOR COMPANY, Seoul (KR)

(21) Appl. No.: 13/312,789

(22) Filed: Dec. 6, 2011

(30) Foreign Application Priority Data
Jun. 29, 2011 (KR) 10-2011-0063838

(51) Int. Cl. B60W 20/00; B60W 10/06; B60W 10/08; H02P 7/00

(52) U.S. Cl. 701/22; 318/461; 180/65.265; 903/930

(57) ABSTRACT

Disclosed is a control system and method for a hybrid vehicle. More specifically, system is configured to calculate a target speed of the first motor/generator according to output speed of the engine, calculate an error speed between a real speed and the target speed of the first motor/generator, apply a compensation value to the error speed, and calculate a target torque of the first motor/generator by applying proportional gain and integrated gain to the compensated error speed of which the compensation value is applied. Accordingly, an error speed is detected between a target speed and a real speed of the first motor/generator according to driving conditions of the engine and the first motor/generator quickly reaches the target speed and the vibration is prevented by applying a compensation value to the error speed such that the control efficiency of entire shifting system is improved.

### CROSS-REFERENCE TO RELATED APPLICATION

This application claims priority to and the benefit of Korean Patent Application No. 10-2011-0063838 filed in the Korean Intellectual Property Office on Jun. 29, 2011, the entire contents of which are incorporated herein by reference.

### BACKGROUND OF THE INVENTION

(a) Field of the Invention

The present invention relates to a control system and method of a hybrid vehicle that achieves a continuous variable transmission through an engine, a first motor/generator, and a second motor/generator.

(b) Description of the Related Art

Generally, an automatic transmission uses a hydraulic pressure to shift gears in a multi step process so as to output the appropriate amount of torque generated by the rotational torque of an engine/motor according to driving conditions. In some hybrid vehicles, two motors/generators are connected to an engine through a planetary gear set, wherein the motors/generators are controlled to achieve continuous variable transmission.

The engine, the first and second motor/generators, and two planetary gear sets are used to continuously vary the output speed of a transmission according to driving conditions of the vehicle. Here, each speed of the first and second motors/generators are controlled accordingly. The first motor/generator is speed controlled according to the driving condition of the engine and the second motor/generator is torque controlled together with the engine so as to control the entire output torque.

Particularly, operating characteristics of the engine are determined depending on the driver's acceleration demand and system conditions. The first motor/generator is proportional integration (PI) speed controlled depending on the operating characteristics of the engine, and overall efficiency is increased or decreased by the control efficiency of the first motor/generator that is PI speed controlled.

However, if a proportional gain (P gain) is larger when that the first motor/generator is PI controlled, the responsiveness is improved, but vibration can be generated due to torque fluctuations, and if a P gain is small, vibrations are not generated, but the responsiveness is deteriorated so that the entire control efficiency is deteriorated as a result.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a control system and method of a hybrid vehicle having advantages of improving a control efficiency of entire system by controlling a first motor/generator to quickly reach a target speed and preventing a vibration thereof.

More specifically, an internal combustion engine and a first motor/generator are employed to assist the rotation of the engine. In one embodiment of the present invention the system may be configured to calculate a target speed of the first motor/generator according to output speed of the engine, calculate an error speed between a present real speed and the target speed of the first motor/generator, apply a compensation value to the error speed, and calculate a target torque of the first motor/generator by applying P gain and I gain to the compensated error speed that the compensation value is applied. Furthermore, if the error speed is larger than a predetermined value, the compensation value ranges from 0 to 1. However, if the error speed is less than the predetermined value, the compensation value is 1.

When the target torque of the first motor/generator is calculated by applying a P gain and a I gain to the compensated error speed, a first value is calculated by multiplying P gain to the compensated error speed, a second value is calculated by integrating the value that is calculated by multiplying I gain to the compensated error speed, and the first value and the second value are added to calculate the target torque of the first motor/generator. The output torque of the first motor/generator may be controlled according to the target torque of the first motor/generator. The second motor/generator may assist rotation torque that is outputted through the first motor/generator and the engine. The engine may be disposed to rotate a first carrier of a first planetary gear set, and the first motor/generator may be disposed to rotate the first ring gear of the first planetary gear set.

Furthermore, a second planetary gear set may be disposed near the first planetary gear set, and the second motor/generator may rotate the first sun gear of the first planetary gear set and the second sun gear of the second planetary gear set simultaneously.

As stated above, an error speed in some embodiments of the present invention may be configured to be detected between a target speed and a real speed of the first motor/generator according to driving conditions of the engine and the first motor/generator to quickly reach the target speed and thereby prevent vibration by applying a compensation value to the error speed so that the control efficiency of entire shifting system is improved in the hybrid vehicle according to the present invention.

### BRIEF DESCRIPTION OF THE DRAWINGS

FIG. 1 is a schematic diagram of a shifting system of a hybrid vehicle according to an exemplary embodiment of the present invention.

FIG. 2 is a flowchart showing a method for controlling a speed of a motor/generator in a hybrid vehicle according to an exemplary embodiment of the present invention.

FIGS. 3A, B are graphs showing variations of output torque of a motor/generator in a hybrid vehicle according to an exemplary embodiment of the present invention.

FIG. 4 is a graph showing error speed and variations of torque of a motor/generator in a hybrid vehicle according to an exemplary embodiment of the present invention.

FIG. 5 is a flowchart showing a method for controlling a motor/generator in a hybrid vehicle according to an exemplary embodiment of the present invention.

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of hybrid vehicles in general such as passenger automobiles including sports utility vehicles (SUV), buses, trucks, various commercial vehicles, watercraft including a variety of boats and ships, aircraft, and the like, and includes hybrid vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

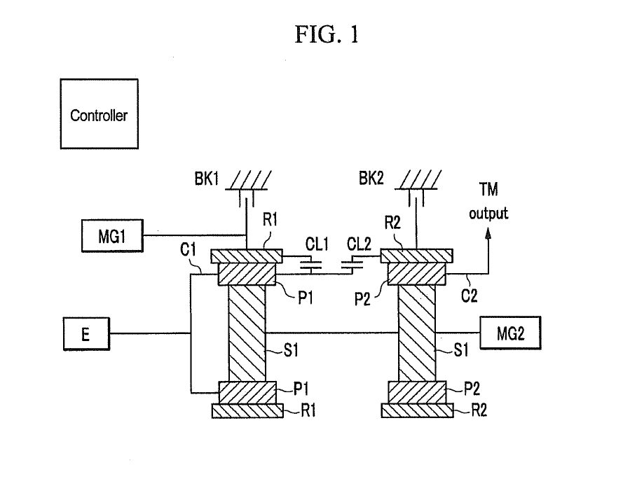

FIG. 1 is a schematic diagram of a shifting system of a hybrid vehicle according to an exemplary embodiment of the present invention. Referring to FIG. 1, a hybrid vehicle shifting system includes an engine (E), a first planetary gear set, a second planetary gear set, a first motor/generator (MG1), a second motor/generator (MG2), a first clutch (CL1), a second clutch (CL2), a first brake (BK1), a second brake (BK2), and a transmission output shaft (TM output).

The first planetary gear set includes a first sun gear (S1) in a central portion thereof, a first pinion gear (P1) that circumscribes on the first sun gear (S1), and a first ring gear (R1) that the first pinion gear (P1) inscribes. More specifically, a first carrier (C1) connects the first pinion gears (P1) to rotate based on the first sun gear (S1).

The second planetary gear set includes a second sun gear (S2) in a central portion thereof, a second pinion gear (P2) that circumscribes on the second sun gear (S2), and a second ring gear R2 that the second pinion gear (P2) inscribes. A second carrier (C2) connects the second pinion gears (P2) to rotate based on the second sun gear (S2).

The output shaft of the engine (E) is connected to the first carrier (C1) and the engine (E) rotates the first carrier (C1) based on the first sun gear (S1). The first motor/generator (MG1) is disposed to rotate the first ring gear (R1). Further, the first brake (BK1) is disposed to selectively fix the rotation of the first ring gear (R1). The first sun gear (S1) is connected to the second sun gear (S2) through one shaft such that the gears (S1) and (S2) rotate together and the second motor/generator (MG2) is disposed and configured to rotate the second sun gear (S2).

The first clutch (CL1) selectively connects the first carrier (C1) with the first ring gear (R1) so that the combination of the two rotate together and the second clutch (CL2) selectively connects the first carrier (C1) with the second ring gear (R2) so that they too rotate together.

The second brake (BK2) is disposed to selectively fix the rotation of the second ring gear (R2). Further, the second carrier (C2) is connected to an output shaft (TM output) of the transmission to transfer the torque from the engine (E), the first motor/generator (MG1), and the second motor/generator (MG2) to the drive wheel. The first motor/generator (MG1) optimally controls the rotation speed of the engine (E) through the first ring gear (R1). Additionally, a control device, e.g., a controller may be employed to operate and control the illustrative embodiment of the present invention.

In the illustrative embodiment of the present invention, a target speed of the first motor/generator (MG1) is set according to at least one driving condition of the engine (E), a real actual speed of the vehicle thereof is detected to determine if the vehicle has reached the target speed, and an error speed is detected between the real speed and the target speed. Further, the target torque is calculated by PI (proportional integration) controlling the error speed and the power inputted into the first motor/generator (MG1) is controlled by a separate control portion so as to reach the target torque.

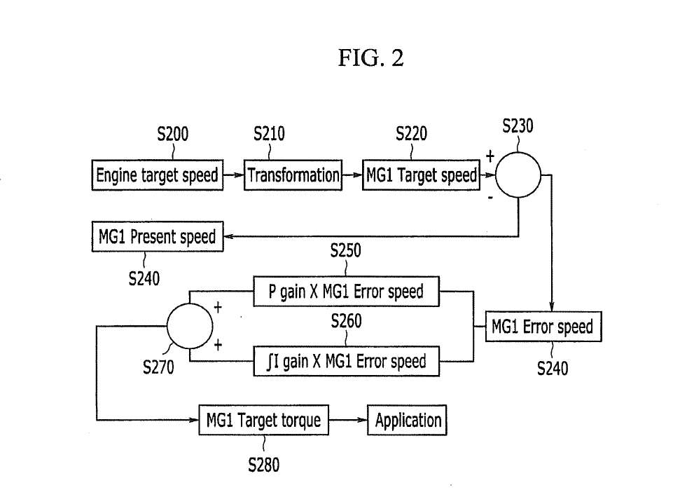

FIG. 2 is a flowchart showing a method for controlling a speed of a motor/generator in a hybrid vehicle according to an exemplary embodiment of the present invention. Referring to FIG. 2, an engine target speed of the engine (E) is detected in a S200, the engine target speed is transformed in a S210, and a motor target speed of the first motor/generator (MG1) is calculated in a S220. The current motor speed of the first motor/generator is deducted from the motor target speed in a S230, and the error speed of the first motor/generator (MG1) is calculated in a S240.

Further, a proportional gain (P gain) is multiplied to the error speed in a S250 and an integration gain (I gain) is multiplied to the error speed in a S260. The two values are added each other in a S270, the target torque of the first motor/generator (MG1) is calculated in a S280, and the power is supplied so as to achieve the target torque in a S290.

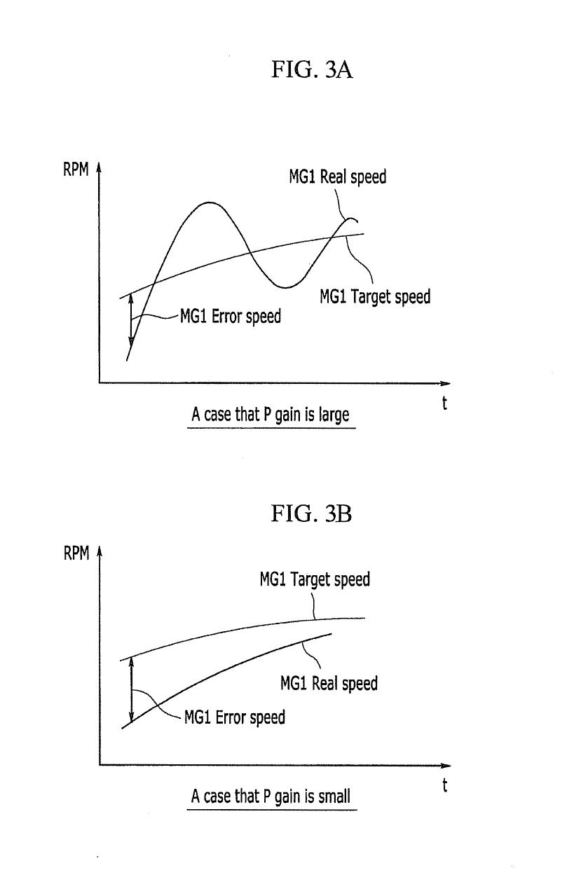

FIGS. 3A,B are graphs showing variations of output torque of a motor/generator in a hybrid vehicle according to an exemplary embodiment of the present invention, which compares speed variations of the motor/generator according to P gain size in PI speed control. Referring to an upper graph FIG. 3A and a lower graph in FIG. 3B, as shown, a horizontal axis denotes time and a vertical axis denotes a rotation speed, wherein P gain is large in the upper graph and P gain is small in the lower graph. In the upper graph, an error speed is formed between the target speed and the real/actual speed of the first motor/generator (MG1), the error speed repeats a plus and minus function to generate vibration when the P gain is large. Further, in the lower graph, the error speed is formed between the target speed and the real/actual; speed of the first motor/generator (MG1), wherein it takes a long time for the real speed to reach the target speed.

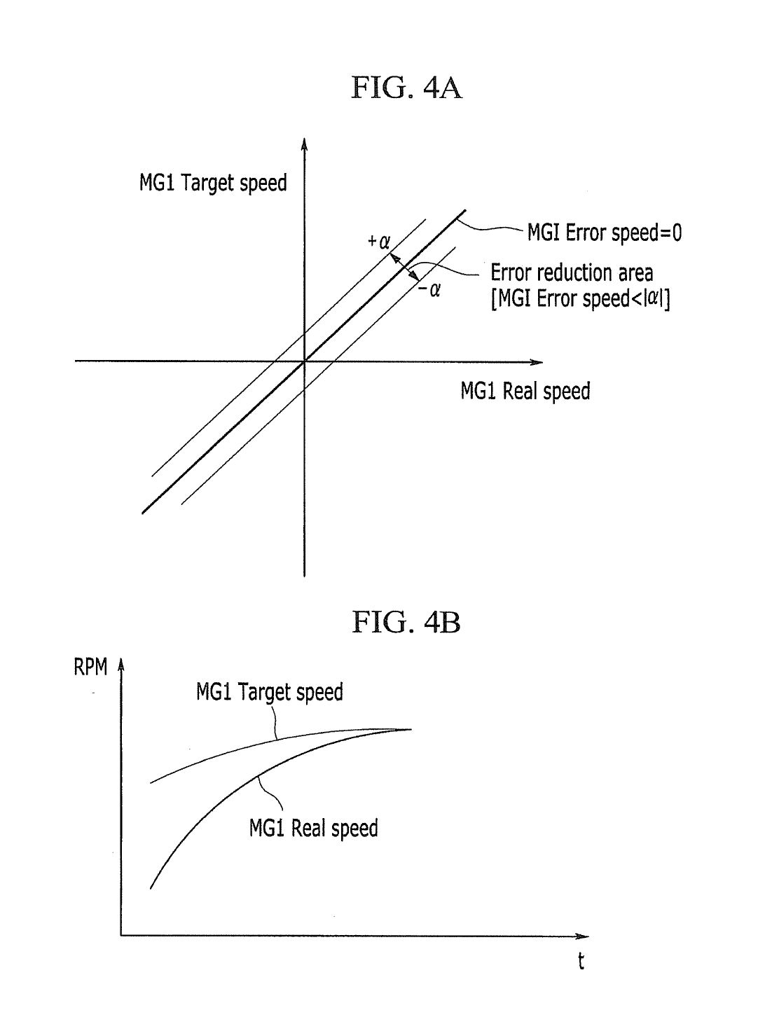

FIG. 4 is a graph showing error speed and variations of torque of a motor/generator in a hybrid vehicle according to an exemplary embodiment of the present invention. Referring to (a) of FIG. 4, a horizontal axis denotes a real/actual speed of the first motor/generator (MG1) and a vertical axis denotes a target speed of the first motor/generator (MG1). A error speed zero line that error speed between the actual speed and the target speed is 0 is drawn and an error reduction area is formed along the error speed zero line by a range of +− alpha (α).

In an exemplary embodiment of the present invention, when the error speed is in the error reduction area, it signifies that the difference between the target speed and the real speed is small and when the error speed is out of the error reduction area, it signifies that the difference between the target speed and the real speed is large. Accordingly, when the error speed is within the error reduction area, a compensation value that is included from 0 to 1 is applied to minimize a variation width of the error speed.

Further, when the error speed is outside of the error reduction area, the compensation value is not applied to the error speed of the first motor/generator to quickly reduce the size of the error speed. Here, not applying the compensation value to the error speed signifies that the compensation value is 1.

Referring to (b) of FIG. 4, the error speed between the target speed and the real speed of the first motor/generator (MG1) is larger at an early stage, but the error speed is quickly diminished such that the real speed quickly approaches the target speed.

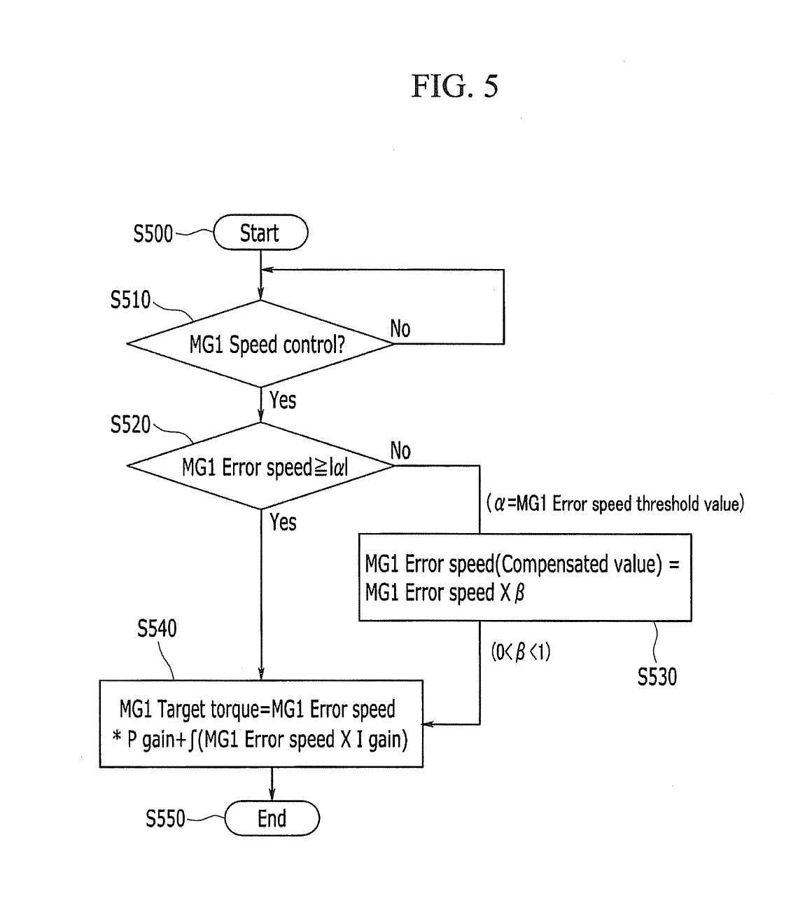

FIG. 5 is a flowchart showing a method for controlling a motor/generator in a hybrid vehicle according to an exemplary embodiment of the present invention. Referring to FIG. 5, a control starts at S500 and it is then determined whether the speed of the first motor/generator (MG1) is controlled or not in S510. If the first motor/generator is determined to be controlled, it is determined whether the error speed of the first motor/generator (MG1) is within the reference value (alpha a) range or not in a S520. If the error speed is within the reference value range, S530 and S540 are performed, and if the error speed is outside of the reference value range, S530 is performed and S540 is not performed.

A proportional gain (P gain) is multiplied to the error speed of the first motor/generator (MG1) in S540, an integration gain (I gain) is multiplied to the error speed and then integrated, and then two values are added to calculate a target torque of the first motor/generator MG1. A compensation value (0<β<1) is multiplied to the error speed of the first motor/generator (MG1) in a S530 and then S540 is performed. Accordingly, the error speed becomes smaller through the S530, the target torque of the first motor/generator MG1 is also smaller, and the vibration of the motor is reduced.

The error speed is applied as it is in a S540, wherein it can be considered that the compensation value (β) is 1. More particularly, the compensation value 1 is applied in a S540, and it is determined that the compensation value ranges from 0 to 1 in a S530.

Furthermore, the present invention may be embodied as computer readable media on a computer readable medium containing executable program instructions executed by a control device such as a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, such as a telematics server and controller area network.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

S1: first sun gear
P1: first pinion gear
RE first ring gear
C1: first carrier
BK1: first brake
BK2: second brake
CL1: first clutch
CL2: second clutch
E: engine
MG1: first motor/generator
MG2: second motor/generator
S2: second sun gear
P2: second pinion gear
R2: second ring gear
C2: second carrier
TM output: output shaft (transmission)

What is claimed is:

1. A control method of a hybrid vehicle that includes an internal combustion engine and a first motor/generator for assisting the rotation of the engine, comprising:
calculating, by a control device, a target speed of the first motor/generator according to output speed of the engine;
calculating, by the control device, error speed between a actual speed and the target speed of the first motor/generator;
applying, by the control device, a compensation value to the error speed; and
calculating, by the control device, a target torque of the first motor/generator by applying a proportional gain and an integrated gain to the compensated error speed of which the compensation value is applied.

2. The control method of a hybrid vehicle of claim 1, wherein when the error speed is greater than a predetermined value, the compensation value ranges from 0 to 1.

3. The control method of a hybrid vehicle of claim 1, wherein when the error speed is less than a predetermined value, the compensation value is 1.

4. The control method of a hybrid vehicle of claim 1, wherein when the target torque of the first motor/generator is calculated by applying a proportional gain (P gain) and an integrated gain (I gain) to the compensated error speed, a first value is calculated by multiplying P gain to the compensated error speed, a second value is calculated by integrating the value that is calculated by multiplying I gain to the compensated error speed, and the first value and the second value are added to calculate the target torque of the first motor/generator.

5. The control method of a hybrid vehicle of claim 4, wherein the output torque of the first motor/generator is controlled according to the target torque of the first motor/generator.

6. The control method of a hybrid vehicle of claim 1, wherein the second motor/generator assists rotation torque that is outputted through the first motor/generator and the engine.

7. The control method of a hybrid vehicle of claim 1, wherein the engine is disposed to rotate a first carrier of a first planetary gear set, and the first motor/generator is disposed to rotate the first ring gear of the first planetary gear set.

8. The control method of a hybrid vehicle of claim 7, further comprising a second planetary gear set that is disposed near the first planetary gear set,
wherein the second motor/generator rotates the first sun gear of the first planetary gear set and the second sun gear of the second planetary gear set simultaneously.

9. A control method of a motor, comprising:
calculating, by a control device, a target speed of a first motor/generator;
calculating, by the control device, an error speed between a real speed and the target speed of the first motor/generator;
applying, by the control device, a compensation value to the error speed; and
calculating, by the control device, a target torque of the first motor/generator by applying proportional gain (P gain) and integrated gain (I gain) to the compensated error speed of which the compensation value is applied.

10. The control method of a motor of claim 9, wherein when the error speed is less than a predetermined value, the compensation value is larger than 0 and less than 1.

11. The control method of a motor of claim 9, wherein when the error speed is less than a predetermined value, the compensation value is 1.

12. The control method of a motor of claim 9, wherein when the target torque of the first motor/generator is calculated by applying P gain and I gain to the compensated error speed,
a first value is calculated by multiplying P gain to the compensated error speed, a second value is calculated by integrating the value that is calculated by multiplying I gain to the compensated error speed, and the first value and the second value are added to calculate the target torque of the first motor/generator.

13. The control method of a motor of claim 12, wherein the output torque of the first motor/generator is controlled according to the target torque of the first motor/generator.

14. A computer readable medium containing executable program instructions executed by a control device, comprising
program instructions that calculate a target speed of a first motor/generator;
program instructions that calculate an error speed between a real speed and the target speed of the first motor/generator;
program instructions that apply a compensation value to the error speed; and
program instructions that calculate a target torque of the first motor/generator by applying proportional gain (P gain) and integrated gain (I gain) to the compensated error speed of which the compensation value is applied

15. The computer readable medium of claim 14, wherein when the error speed is less than a predetermined value, the compensation value is 1.

16. The computer readable medium of claim 9, wherein when the target torque of the first motor/generator is calculated by applying P gain and I gain to the compensated error speed,
a first value is calculated by multiplying P gain to the compensated error speed, a second value is calculated by integrating the value that is calculated by multiplying I gain to the compensated error speed, and the first value and the second value are added to calculate the target torque of the first motor/generator.

17. The computer readable medium of claim 16, wherein the output torque of the first motor/generator is controlled according to the target torque of the first motor/generator.
